(19) United States
(12) Patent Application Publication
(10) Pub. No.: US 2003/0094067 A1
(43) Pub. Date: May 22, 2003

(54) Composite handlerbar for bicycles

(75) Inventors: Kent Whiting, Campbell, CA (US); Kevin Hulick, Corvallis, OR (US)

Correspondence Address: Jeffrey Jall, 212 Clinton Street, Santa Cruz, CA, 95062, US

(73) Assignee: Sandpoint Design, Inc.

(21) Appl. No.: 10/261,531

(22) Filed: Oct. 1, 2002

Related U.S. Application Data
(60) Provisional application No. 60/332,500, filed on Nov. 16, 2001.

(51) Int. Cl. B62K 21/12

(52) U.S. Cl. 74/551.1

(57) ABSTRACT

### 37 C.F.R. 1.77(a)(12)

A one-piece handlebar for bicycles composed of one or more composite materials. The handlebar may be configured as a curved drop style handlebar, bent, or swept forward style, or other configuration, for road or off-road use. The handlebar may be provided with different finishes and include a brake lever attachment area provided with a very rough textured finish. The handlebar may have two sets of indentations or cable troughs for the shifter and brake cables to be run recessed along the handlebar and not interfere with the riders hands. The handlebar may be hollow, with the wall thickness varied with more composite material in higher stress areas of the handlebar.

### CROSS-REFERENCE TO RELATED APPLICATIONS

This application is related to and claims priority from U.S. Provisional Patent application Serial No. 60/332,500 filed, Nov. 16, 2001.

### BACKGROUND OF THE INVENTION

### 37 C.F.R. 1.77(a)(7)

1. Field of Invention

This invention relates to handlebars for bicycles and in particular to one-piece composite handlebars for bicycles.

2. Description of the Related Art

There are numerous types and styles of bicycle handlebars which have been proposed and developed. Various handlebars have been developed for both road and off-road bicycles. Configurations such as curved drop style, “cowhorn”, or swept forward style, for example are well known.

The present invention is a one-piece composite handlebar for bicycles. It is the primary object of this invention to provide a one-piece composite handlebar for bicycles which has increased strength, fatigue safety and durability, comfort, and safety.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims.

### BRIEF SUMMARY OF THE INVENTION

### 37 C.F.R. 1.77(a)(8)

To achieve the foregoing objects, and in accordance with the purpose of the invention as embodied and broadly described herein, a one-piece composite handlebar is disclosed and may be configured as a curved drop style handlebar, bent, or swept forward style, or other configuration, for road or off-road use. Preferably, the left and right hand sides of the handlebar are symmetric about the center, with a portion for the user to place their hands and an area for brake and shift lever attachment. The handlebar may be provided with different finishes, such as a majority of the handlebar painted with a smooth clear coat finish, and the brake lever attachment area provided with a very rough textured finish. The handlebar may have two sets of indentations or cable troughs allowing for the shifter and brake cables to be run recessed along the handlebar and not interfere with the riders hands. The structure of the handlebar is preferably hollow, with the wall thickness varied as more composite material is required in higher stress areas of the handlebar. The composite material is preferably comprised of multiple layers of carbon and aramid fibers in an uncured epoxy matrix, but may be other composites as desired. The present invention provides a one-piece handlebar for bicycles which has increased fatigue safety and product lifetime, increased rider comfort due to vibration dampening, increased rider comfort due to shape variability, and reduced weight of the handlebar as compared to prior handlebars.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is an perspective view of a one-piece composite handlebar for bicycles, according to the invention.

FIG. 2. is an orthographic front view of such handlebar, according to the invention.

FIG. 3, shows the primary location for hand placement on such handlebar, according to the invention.

FIG. 4, is a cross sectional view through location 6 in FIG. 2, according to the invention.

FIG. 5, is a orthographic front view of such handlebar showing a preferred surface finish, according to the invention.

FIG. 6, is an orthographic side view of such handlebar, according to the invention.

FIG. 7, is a cross sectional view through location 12 of such handlebar, according to the invention.

FIG. 8, is a cross sectional view through location 12 of such handlebar inside of a two piece steel mold, according to the invention.

FIG. 9, shows an alternative construction method of such handlebar, according to the invention.

FIG. 10, is a cross sectional view of such handlebar at location 12, according to the invention.

### DETAILED DESCRIPTION OF THE INVENTION

### 37 C.F.R. 1.77(a)(10)

Reference will now be made in detail to the present preferred embodiments of the invention as illustrated in the accompanying drawings.

In accordance with the present invention, there is provided in a preferred embodiment of the invention, a one-piece composite handlebar is shown providing increased fatigue safety and product lifetime, increased rider comfort due to vibration damping, and shape variability, and reduced weight. The one-piece composite handlebar is preferably curved and may be tubular with a circular cross-section or otherwise. A textured surface area may be provided. As used herein a composite is a material comprised of two or more dissimilar materials, the matrix and the reinforcement. Any combination can be made from the following lists of matrix materials and reinforcement materials to make a composite. The matrix materials may be thermosetting resins such as epoxy, polyester, cynate ester, or thermoplastic resins such as nylon, ABS, or. polystyrene. The reinforcement materials may be one or more of the following materials carbon fiber, glass fiber, boron fiber, wood fiber, ceramic fiber, metal coated fibers, metal fibers, thermosets, thermoplastics, and aramid or para-aramid. For example, the one-piece composite handlebar may be composed of multiple layers of carbon and aramid fibers in an uncured epoxy matrix, or composed of other composites.

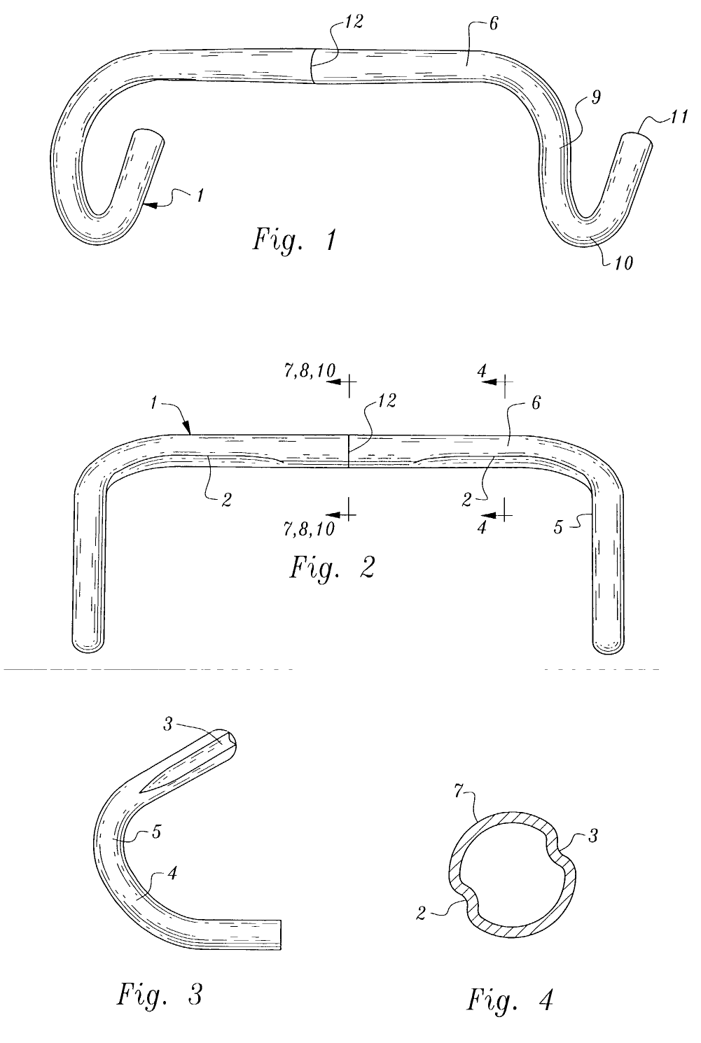

In FIG. 1, a preferred embodiment of a one-piece composite bicycle handlebar 1, is shown constructed in accordance with the invention. Preferably, the handlebar has the same general appearance of a curved drop style handlebar used predominately on road and cyclo-cross racing bicycles though a handlebar of this shape can be used on a variety of bicycles, such as off road bicycles, and other vehicles and sporting goods. As seen in FIG. 1, preferably the left and right hand sides of the handlebar are symmetric about the center 12.

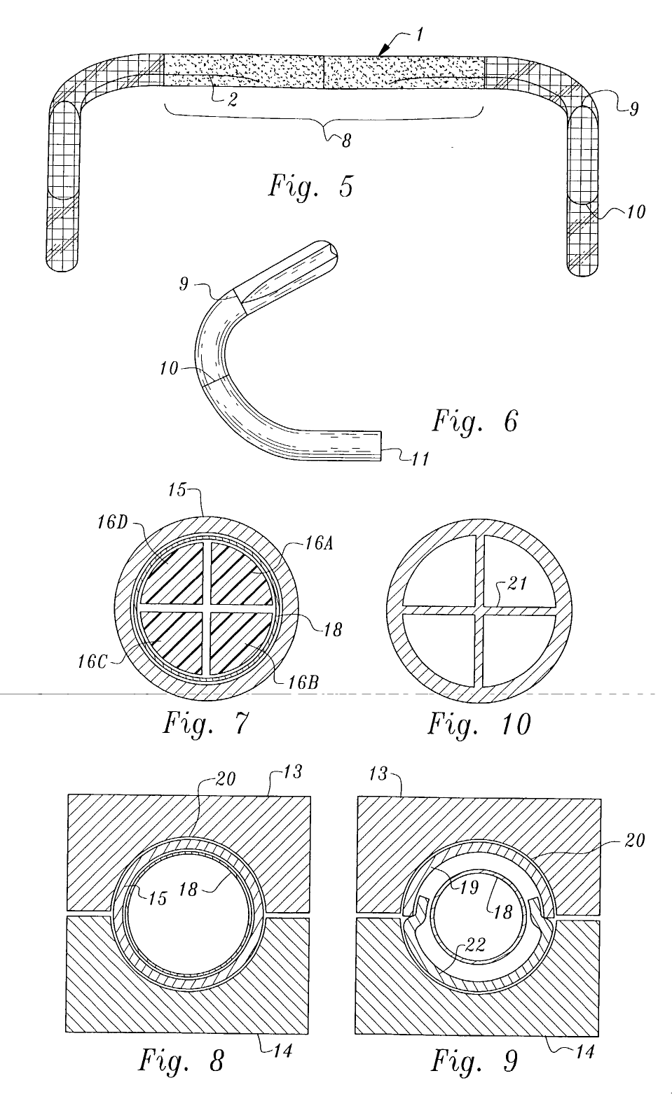

With reference now to FIG. 2 and FIG. 5, which are both orthographic front views of the handlebar 1, and show cable trough 2, which is an indentation in the handlebar. The handlebar preferably has two sets of such cable troughs or indentations 2, and 3, seen in FIG. 4. The cable troughs allow for shifter and brake cables to be run recessed along the handlebar and not interfere with the riders hands. The surface texture may vary as desired. In FIGS. 5 and 6, an example of the handlebar surface finish is shown, with location 8, a carbon weave, gloss epoxy clear coat, position 8 to 9, black paint with gloss epoxy clear coat, position 9 to 10, textured, flat black paint, and position 10 to 11 black paint, epoxy clear coat. Of course, the type, color, and style of paint or texture may be varied as desired.

In FIGS. 3 and 6 show orthographic side views of the handlebar 1, according to a preferred embodiment. The primary location for the user to place their hands is at area 4, seen in FIG. 3. Above this area the brake lever attachment area 5, can be seen. FIG. 3 illustrates how area 5, preferably extends from location 9, to location 10. The majority of the handlebar is painted with a smooth clear coat finish, but the brake lever attachment area 5, has a very rough textured finish. This finish is approximately equal to 120 grit aluminum oxide sandpaper.

With reference now to FIG. 4, it can also be seen that the structure of the handlebar is preferably hollow in nature, but may be otherwise. The wall thickness varies as more composite material is required in higher stress areas of the handlebar. Generally speaking, the wall is thickest at the center 12, for example, about 3 mm, and gets thinner towards the ends, for example, about 1.5 mm. Preferably, the composite material 7, is comprised of multiple layers of carbon and aramid fibers in an uncured epoxy matrix. This combination is referred to as a laminate of pre-impregnated composite material. This is then cured under pressure to form the completed composite structure. The completed structure is approximately 35% resin and 65% fiber by volume. However, other composites may be used to make one-piece handlebar 1. For example, the composite may include a resin-impregnated fabric having unidirectional fibers impregnated with a heat curable resin, multiple layers of unidirectional fibers, unidirectional fibers of different layers which extend longitudinally in different directions, or the same direction, or other fiber and resin combinations. The composite being a material comprised of two or more dissimilar materials, the matrix and the reinforcement. Any combination can be made from the following lists of matrix materials and reinforcement materials to make a composite. The matrix materials may be thermosetting resins such as epoxy polyester, cynate ester, or thermoplastic resins such as nylon, ABS, or polystyrene. The reinforcement materials may be one or more of the following materials carbon fiber, glass fiber, boron fiber, wood fiber, ceramic fiber, metal coated fibers, metal fibers, thermosets thermoplastics, aramid or para-aramid.

The preferred construction of the handlebar 1, is shown in FIGS. 7 and 8. FIG. 7 is a view of the cross section at location 12, of the composite laminate assembly. At the center is a solid silicone rubber mandrel 16, that is preferably comprised of several tapered pieces of silicone rubber 16a, 16b, 16c, and 16d. There are three sets of mandrels used, one for each side of the handlebar, and one for the center. A section of thin walled plastic tubing 18, is slid over the assembled mandrel 16. The uncured composite material 15, is placed around the tubing 18 in several overlapping layers. The individual layers should be placed at varying angles to each other to ensure proper load distribution throughout the structure, for example, 0 degrees, 30 degrees, 45 degrees, 90 degrees, −45 degrees, −30 degrees, and 0 degrees. After the required composite material 15, has all been formed into an assembly it has enough structural stability that the mandrels 16, can be removed from each end. The assembly can now be cured in a mold.

In FIG. 8, a cross section at location 12, of the composite assembly inside of a two-piece steel mold with a top 13 and a bottom 14, is shown. The mold halves 13, and 14, are pressed together and heated to the cure temperature of the epoxy matrix material, in this case 250 degrees F. At the same time the plastic tubing 18, is pressurized with air to force the composite material 15, to the surface of the mold cavity. This forms the composite material 15, into the handlebar. After dwelling at the curing temperature, the handlebar can be removed from the mold halves. The plastic tubing 18, is then removed and the structurally sound one-piece composite handlebar is ready for cosmetic finishing. This process is sometimes referred to as internally pressurized bladder molding.

In operation, bicycle riders or mechanics will have no difficulty in using the handlebar 1. The handlebar is preferably connected to the bike via a traditional stem which clamps around the handlebar in the center location 12. Brake levers or combination shift and brake levers are attached to the handlebar in area 5. The shift and brake cables may be routed through cable troughs 2 and 3. The handlebar should be wrapped with traditional bicycle handlebar tape in the standard fashion for added comfort and control while riding. The primary location for the rider to hold the handlebar is in area 4, however the rider may place their hands at any location.

One-piece composite handlebar 1, is safer for the bicycle rider due to increased fatigue resistance. Prior handlebars have been made from metals. Due to the desire for lighter weight bicycle parts, metal racing handlebars have reduced wall sections compared to the heavier standard metal handlebars. This reduction in wall thickness has an adverse affect on the fatigue life of the handlebar. Several commercially available metal handlebars do not pass the in phase handlebar fatigue test as described in the ISO 4210 testing standard. Some of these bars are sold with a warning that the handlebar needs to be replaced after a single year of use. The new composite design is lightweight and still able to last more than four times the requirement specified by the ISO 4210 testing with no weakening or any damage. This represents more than a lifetime of safe use for the bicycle rider. The concern of a metal handlebar suddenly failing from fatigue without any warning is also eliminated with the on-piece composite handlebar 1, of the invention.

In addition to one-piece composite handlebar 1, being safer as a result of the fatigue strength, the brake lever attachment area 5, is also safer in the invention. A common place for the riders to place their hands, and therefore body weight, is on the top of the brake levers, also called the brake hoods. The brake levers attach to the handlebar at area 5. The common method of attachment is a thin metal band that slides over the handlebar. This band is tightened and forces the plastic base of the brake lever against the handlebar. Due to the nature of bent metal tubing, the shape of the metal handlebar in this area is irregular, not round, not smooth and has an inconsistent wall thickness. The irregular shape and the thin wall of the tubing in this area can lead to the metal band clamp digging into the handlebar and causing a stress concentration. This causes additional concern for metal fatigue, though there is no standardized test for this. There is also a possibility of this clamp to loosen during use due to the localized fatigue and deformation of the handlebar. The cross section of the composite handlebar is created in the most efficient shape for the structure in this area, that is, circular. Not only does this shape help resist the normal loading of the handlebar, but it also reduces the contact stresses of the round metal band clamp of the brake lever. The wall of the composite handlebar tubing is consistent and thicker than that of the metal handlebar. This is structurally more sound, but prevents the metal band clamp from digging into the composite material. Although this is desirable, combined with a lower coefficient of friction between the plastic base of the brake lever and the composite material, it results in a brake lever attachment that is not optimal. To compensate for this, the surface of area 5, is coated with a rough textured finish. This provides increased friction between the metal band, the plastic base, and the handlebar. This finish gives the handlebar a brake lever attachment that is more secure and safer than that possible on the metal handlebar. Preferably, the textured finish is formed by painting area 5, with a flat paint such as that used to prepare the surface of a classroom chalkboard. 120 grit aluminum oxide sand blaster media is immediately applied to the wet paint. After the paint has dried, any loose sand is brushed off. Then the area is again painted with the same flat paint to secure the sand in place.

One-piece composite handlebar 1, is more comfortable for the bicycle rider due to increased vibration damping. The composite material comprising the handlebar is able to dampen out the vibrations of normal use ten times better than the existing metal handlebars. This makes for a more enjoyable riding experience for the rider.

In addition to the overall rider fatigue reduction, making the handlebar out of composite materials can increase the comfort of the rider's hands and allow them to have a better grip of the handlebar. A common location for the rider to grip the handlebar is at location 4. Many metal handlebars are made in an attempt to match the shape of the rider's hands in the metal at location 4. Any attempt to do this with a bent metal tube is severely limited. It is very difficult to have a metal tube remain round in cross section or to change diameter through the bending process. It is also difficult to have multiple bends of differing radii or a bend with a constantly changing radius. The result is typically a shape that is comfortable for the rider in only one specific position. However, by making the handlebar out of composites, area 4, is able to have a comfortable round cross section, and have a continuous shape with multiple radii. This allows the shape of area 4, to be comfortable for a wider range of hand shapes and positions with no increase in production cost or weight as would be the case with a metal handlebar.

Current consumer preferences and market conditions make the composite handlebar as described above the best suited version to produce and have the broadest acceptance. However, there are other variations which provide valid improvements, but may not be as readily accepted in a conservative marketplace. Those variations are described below.

Though the handlebar described is typically used on road bicycles, it can really be used on any style of bicycle. Also, the handlebar is described as a drop style handlebar, however the invention can also be made in the shape of a “cow horn” or similar forward swept bicycle handlebar. The designs and methods can apply to any bent shaped handlebar. The described handlebar is also symmetric about the center, however it does not need to be.

The invention preferably utilizes an added on rough surface finish to aid in the attachment of the bicycle brake levers at area 5. Alternately the rough finish could be added to the handlebar during the molding process. The textured material could be added to the mold cavity or placed on the preformed material prior to molding. The mold itself could have a rough surface finish to add to the effect. The rough material may be, for example, 120 grit aluminum oxide, however other materials and other grit sizes can be used. For instance a 100 grit silicone dioxide can be used. There are a variety of materials and particle sizes that can be adapted to this use. The grit material can also be bonded onto the handlebar with an adhesive instead of with paint.

Another embodiment is to mold in a physical detail at area 5, which is shaped to mate with the metal band clamp and/or the plastic base of the brake lever. This detail could prevent the brake lever from being able to move once tightened, essentially locking it into place. Or alternatively, another method is to have a thin layer of plastic or rubber material which is softer than the handlebar and break lever base located on area 5. This material could either be co-molded with the handlebar, over-molded on top of the cured handlebar, or bonded onto the finished handlebar. As an example, Santoprene from Advanced Elastomer Systems is one such soft material. This material would act as a gasket to increase the surface area of contact, increase the friction, and provide a physical connection.

A very secure method of brake lever attachment is to mold in the band clamp of the brake lever into the handlebar at area 5, or a similarly shaped metal ring with a threaded stud. During molding the metal ring could be placed to be on the internal surface of the handlebar, the external surface of the handlebar, or fully encapsulated by the composite material within the tubing wall. The metal part would not need to be a full ring, it could be as simple as a threaded stud with a small base that could provide the physical connection with the composite. Alternately, the metal part could be bonded or other ways attached to the surface of the handlebar after molding. An exposed metal ring could be co-molded with the composite to provide a bearing surface for the metal clamp to isolate the composite structure 7, from any point or contact loading, yet not interfere with the structural advantages of the base composite.

The invention as described preferably has two separate cable troughs 2 and 3, however a handlebar can be made with only one trough or with none at all. Additional troughs could be added to accommodate other accessories such as wiring for speedometers or cables for lighting systems. Also, the troughs could all be combined into one large trough. Alternatively, instead of having cable troughs, the handlebar could also have entry and exit ports on the surface which allow for the cables to utilize the empty space within the structure. The cables could be allowed to be free within the empty space. Alternately a section of metal or plastic tubing could be attached to each port during construction so that the cables could easily be removed and reinstalled by the user. The ports could simply be holes in the handlebar or they could be separately created parts which are attached to the handlebar after molding.

The structure of the handlebar is described as being hollow in nature, but it does not have to be hollow in part or in whole. For instance at the center 12, of the handlebar, the structure could be totally solid composite material, yet hollow on either side. Also the composite structure can have internal strengthening ribs 21, as shown in FIG. 10. FIG. 10 is a cross section view of the handlebar at location 12. These can still be formed by using the same construction process, but with multiple plastic tubes providing the internal pressure. A separate part could also be created prior to molding which is co-molded with the composite and creates the strengthening ribs 21. This could be made from composite material, plastic, wood, metal or any other structural material. If multiple inserts were required, then the areas not accessible by the internal plastic pressure tubing 18, would need to be compression molded.

The composite tube cross section of the handlebar has been described as circular. However, the tube section is not limited to being solely circular, any shape is possible. The tube could be ovalized to increase structural properties, or have a tear drop shape for increased aerodynamics. The tube could be shaped in any area to improve the comfort of the rider by making the tubing closely match the shape of a rider's hand, an ergonomic or form fitting shape. There may be details molded into the handlebar to aid in the co-molding, or later over-molding of a soft compound such as Santoprene to provide a comfort grip area on the handlebar at a location such as area 4. The entire handlebar could be over-molded with such a compound to eliminate the need for the traditional handlebar tape that is normally required. Details may be molded in the handlebar to provide locations for the physical locking of or aid in the bonding of a separately molded part. Such added parts could include the above described comfort grip, a lighting system, a cycle computer or other such accessories.

The molding method described utilizes a two piece mold 13, and 14, 250 degree F. cure epoxy pre-impregnated carbon and aramid composite 7, and internal pressure provided by an air filled plastic tube 18. There are many variations on these methods that my be utilized. for example, the mold 13, and 14, could be comprised of more than 2 pieces. The described mold 13, and 14, is steel, but could be made from aluminum, composite materials, plastics, wood, concrete, plaster, or a wide variety of other materials.

The composite material 7, used is comprised of carbon and aramid fibers pre-impregnated with 250 degree F. cure epoxy. However the cure temperature could be higher or lower as there are readily available resin systems that cure from room temperature on up to 400 degree F. and above. The different cure temperatures can be used to lower tooling equipment costs or to increase the service temperature available for the handlebar. The ratio of fiber to resin is described as 65% to 35% by volume, but this ratio can vary greatly depending upon the processes chosen. The resin matrix system also does not have to be epoxy; thermoplastics, polyester, cyanate ester or other resinous polymeric materials can also be used. Different matrix materials are better suited to different tooling arrangements and regional environmental standards.

The fibers which may be used are also not limited to carbon and aramid. Other fibers such as glass, ceramic, PBO, Spectra, boron, wood, and even metal based or metal coated fibers can be used in the handlebar structure. Each fiber has its own advantageous properties. For instance if an accessory for the bicycle (such as a low current safety electric lighting system) required that the handlebar act as a common ground, then metal or metal coated fibers could be incorporated into the composite structure to fulfill this need. The fibers can also be used as a woven fabric or a non-woven or matt fabric, not just as unidirectional fiber sheets as described.

The plastic tubing 18, used to provide internal pressure can be pressurized with not just compressed air, but also other dry gases, or even liquids such as water, heat transfer oil, or other hydraulic fluids. Depending upon the fluid type, mold material, and the matrix cure temperature, the pressurized fluid can be used to heat or cool the composite from the inside as a secondary or primary heating or cooling source.

Tubing 18, itself does not need to be thin walled plastic. The tubing 18, can be thin or thick walled silicone rubber, latex, or even natural such as sealed lambskin or intestine. The tubing also doesn't need to be pressurized with a fluid. Silicone expands when heated to such an extent that a solid or nearly solid silicone core would expand during heated molding to provide the required pressure to the inside of the composite 7. This process is sometimes referred to as trapped rubber or expanding mandrel molding.

The mandrel 16, used in the composite assembly step can be carried further through the process into molding. As stated above, the silicone will expand when heated. The mandrel 16, can also be used in combination with expanding foam to provide the pressure. The mandrel can also be comprised of a solid piece of foam such as syntactic or polyurethane foam that remains within the handlebar after molding. The mandrel could be balsa wood, a honeycomb material, a eutectic salt, or any other common core materials.

With reference now to FIG. 9, which illustrates another method that can be utilized for construction. FIG. 9 also shows a cross section at location 12, of the composite assembly inside of a two piece steel mold with a top 13, and a bottom 14. It is slightly different in that the composite material is placed into each half of the mold top 13, and bottom 14, separately. The composite material on the top 19 is flush with the mold parting line and the material on the bottom half 22, extends beyond the mold parting line. The plastic pressure tubing 18, is placed in the lower half 14, of the mold. The longer pieces 22, are folded over the pressure tubing 18, before the mold halves 13, 14, are assembled. When the pressure tubing 18, expands the longer material 22 on the bottom is forced to against the top material 19. The overlapping portions cure together and a structurally sound one-piece composite handlebar is formed. Accordingly, the basic method of composite molding also is not restricted to using pre-impregnated composite material. Other methods can be used such as using sheet molding compound, bulk molding compound, compression molding, a “wet-lay-up” process where liquid resin is added to dry fibers in an open mold, or resin transfer molding where liquid resin is added to dry fibers in a closed mold.

The composite structure 7, can be combined with synthetic foam, honeycomb, wood, or elastomers to improve the impact tolerance and vibration damping of the structure. These materials can be wholly internal to the handlebar, or be sandwiched within the layered plies of material in the tubing wall. For instance there could be 1 mm of composite, 1 mm of foam, and another 1 mm of composite to form a 3 mm thick wall. These added materials are not actually considered part of the composite, but rather affect the way the composite behaves, alter the geometry of the composite, or simply dampen out vibrations on their own. The added materials may be placed in localized areas or may be used throughout the handlebar structure.

A more involved method of vibration control could be achieved with the use of piezo-electric material. When properly arranged, this material will release an electric charge when deflected and deflect when subjected to an electric charge. Piezo-electric material can be located within the handlebar in several locations and be connected with a conductive material such as an embedded metal wire or the use of metal fibers in the composite. These can be cleverly arranged in such a manner as to eliminate vibrations in the handlebar. A piezo-electric entity in one section of the bar would be deflected by the vibration and it in turn would activate a different piezo-electric entity to move against this same vibration. This is in effect an active vibration damping system.

In addition to the brake lever attachment area 5, the described primary and alternate methods of increasing the security and safety of this attachment can be applied to any other areas on the handlebar as well. For instance, these methods can be used at the center 12, to aid in stem attachment, or anywhere along the center straight section of the handlebar where accessories such as cycle computers, bells, mirrors, lights, or “aero bars” and other devices which clamp onto the handlebar to give the rider an alternate riding position such as mountain bike bar ends attach.

As is evident from the above description, a wide variety of bicycle handlebars, applications, and systems may be envisioned from the disclosure provided. The methodology described herein is applicable on any bicycle or vehicle which uses handlebars, and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

### 37 C.F.R. 1.77(a)(11)

What is claimed is:

1. A lightweight handlebar for bicycles having increased fatigue safety, longevity, and comfort, comprising:
a one-piece curved handlebar member composed of a composite material.

2. The handlebar of claim 1, wherein said one-piece curved handlebar member is tubular.

3. The handlebar of claim 1, further including a textured, friction coated surface area.

4. The handlebar of claim 1, wherein said one-piece curved handlebar member has a circular cross-section.

5. The handlebar of claim 1, wherein said composite includes a resin-impregnated fabric having unidirectional fibers impregnated with a heat curable resin.

6. The handlebar of claim 1, wherein said composite comprises essentially of multiple layers of unidirectional fibers, and wherein the unidirectional fibers of different layers extend longitudinally in different directions.

7. The handlebar of claim 1, wherein said one-piece curved handlebar is composed of multiple layers of carbon and aramid fiber in an uncured epoxy matrix.

8. The handlebar of claim 1, wherein said one-piece curved handlebar in configured as a cow horn.

9. The handlebar of claim 1, further including means for securing a pair of brake levers.

10. The handlebar of claim 1, further including one or more indentations allowing for a shifter and brake cables to be run recessed along said handlebar.

11. The handlebar of claim 1, further including one or more entry and exit ports.

12. A method for making a one-piece composite handlebar, comprising the steps of:
positioning a mandrel means, one for each side of said handlebar, and one for a center;
positioning a section of plastic tubing over said mandrel means;
placing a composite material around said section of plastic tubing;
removing said mandrel means from said handlebar; and
curing said handlebar in a mold.
